(19) United States
(12) Patent Application Publication
(10) Pub. No.: US 2020/0239012 A1
(43) Pub. Date: Jul. 30, 2020

(54) AGRICULTURAL MACHINE CONTROL METHOD, DEVICE AND SYSTEM

(71) Applicant: SZ DJI TECHNOLOGY CO., LTD., Shenzhen (CN)

(72) Inventors: Jiahang YING, Shenzhen (CN); Zhimeng SHANG, Shenzhen (CN); Minjun QIU, Shenzhen (CN); Jianyun MA, Shenzhen (CN)

(21) Appl. No.: 16/845,872

(22) Filed: Apr. 10, 2020

Related U.S. Application Data
(63) Continuation of application No. PCT/CN2017/107900, filed on Oct. 26, 2017.

(51) Int. Cl. B60W 50/02; B60W 60/00

(52) U.S. Cl. CPC B60W 50/0225; B60W 2050/046; B60W 2300/152; B60W 60/0025

(57) ABSTRACT

An agricultural machine control method includes acquiring control information for an automatic operation mode, controlling the agricultural machine to perform an operation in the automatic operation mode according to the control information, and, in response to determining that the agricultural machine is in an abnormal status, sending an interrupt signal to the agricultural machine to cause the agricultural machine to stop moving and stop the operation. The control information includes an operation path of the agricultural machine.

### CROSS-REFERENCE TO RELATED APPLICATION

This application is a continuation of International Application No. PCT/CN2017/107900, filed Oct. 26, 2017, the entire contents of which is incorporated herein by reference.

### TECHNICAL FIELD

The present disclosure relates to the agricultural machine field, and more particularly, to an agricultural machine control method, device, and system.

### BACKGROUND

With the advancement of smart agriculture, a lot of kinds of advanced technologies have been applied to farmland operations, and a number of autonomous driving equipment e.g., unmanned aerial vehicles for plant protection and agricultural tractors have been produced, which has brought great convenience to farming. In existing technologies, when an agricultural tractor encounters an abnormal situation, the automatic driving operation is mostly stopped by manually pressing the emergency stop switch to prevent losses. The manual control not only causes some trouble to users, but also cannot respond in time.

### SUMMARY

In accordance with the disclosure, there is provided an agricultural machine control method including acquiring control information for an automatic operation mode, controlling the agricultural machine to perform an operation in the automatic operation mode according to the control information, and, in response to determining that the agricultural machine is in an abnormal status, sending an interrupt signal to the agricultural machine to cause the agricultural machine to stop moving and stop the operation. The control information includes an operation path of the agricultural machine.

### BRIEF DESCRIPTION OF THE DRAWINGS

FIG. 1 is a flowchart of a method for controlling an agricultural machine according to one embodiment of the present disclosure.

FIG. 2 is a schematic diagram showing positions of boundary points of an area to be operated according to one embodiment of the present disclosure.

FIG. 3 is a schematic diagram showing positions of obstacles in the area to be operated according to one embodiment of the present disclosure.

FIG. 4 is a schematic diagram showing positions of obstacles in the area to be operated according to another embodiment of the present disclosure.

FIG. 5 is a structural block diagram of an agricultural machine control device according to one embodiment of the present disclosure.

FIG. 6 is a structural block diagram of an agricultural machine control system according to one embodiment of the present disclosure.

FIG. 7 is a structural block diagram of a part of the agricultural machine control system according to one embodiment of the present disclosure.

FIG. 8 is a structural block diagram of another part of the agricultural machine control system according to one embodiment of the present disclosure.

FIG. 9 is a structural block diagram of another part of the agricultural machine control system according to one embodiment of the present disclosure.

### REFERENCE NUMERALS

100—Agricultural machine control device
110—Processor
200—Control device
210—Steering control device
220—Brake control device
230—Accelerator control device
300—Navigation device
310—RTK device
400—Execution device
410—Seeding device
420—Spraying device
500—IMU device
600—Emergency stop switch
700—User operation device
710—Steering wheel
711—Torque sensor
720—Brake pedal
721—First pressure sensor
730—Accelerator pedal
731—Second pressure sensor
1—Area to be operated
10—Boundary point
11—Key point
20—Obstacle point
21—Obstacle area
22—Boundary point of the obstacle

### DETAILED DESCRIPTION OF THE EMBODIMENTS

Technical solutions of the present disclosure will be described in detail with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The agricultural machine control method, device and system of the present disclosure will be described in detail below with reference to the drawings. In the case of no conflict, the features of the following examples and implementations can be combined with each other.

In the present disclosure, an agricultural machine refers to equipment capable of traveling and operating on the ground, e.g., an agricultural tractor.

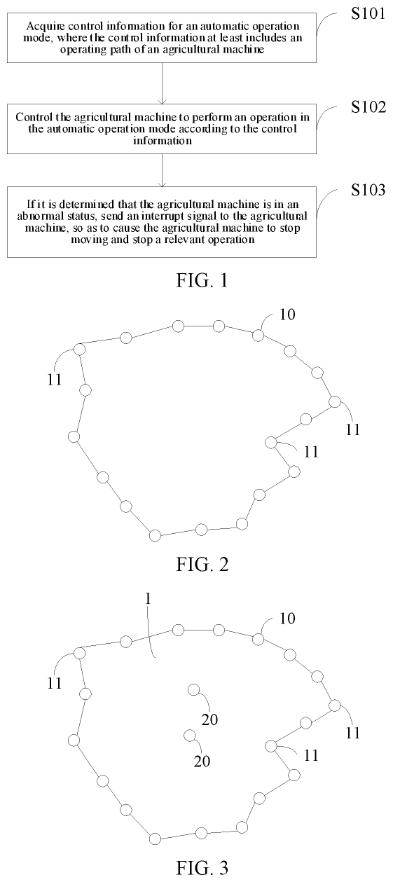

An embodiment of the present disclosure provides a method for controlling an agricultural machine. FIG. 1 is a flowchart of the method for controlling the agricultural machine according to one embodiment of the present disclosure. The method can be implemented, e.g., by the agricultural machine. As shown in FIG. 1, the method for controlling the agricultural machine includes the following.

At S101, control information for an automatic operation mode is acquired and the control information at least includes an operation path of an agricultural machine.

In this embodiment, the control information is input by a user, so that the operation path can be generated according to the need of the user, which is convenient and fast. Specifically, acquiring the geographical information of an area to be operated includes acquiring the geographical information of the area to be operated through an input device of the agricultural machine, where the input device may be a touch screen, a button, or another type. In some embodiments, the input device may be a touch screen, and acquiring the geographical information of the area to be operated through the input device of the agricultural machine includes acquiring the geographical information of the area to be operated through the operation of the user on the touch screen.

In some other embodiments, the input device may be a button, and acquiring the geographical information of the area to be operated through the input device of the agricultural machine includes acquiring the geographical information of the area to be operated through the operation of the user on the button.

S101 may include the following: acquiring geographic information of the area to be operated and current position information of the agricultural machine; and determining an operation path of the agricultural machine according to the geographic information and the current position information of the agricultural machine. The current position information of the agricultural machine can be used to determine a starting position of the agricultural machine when it is operating. Determining the starting position can include: when the current position of the agricultural machine is on the determined operation path, the starting position may be the current position of the agricultural machine; when the current position of the agricultural machine is not on the determined operation path, the starting position may be a position determined according to the current position of the agricultural machine and the operation path, e.g., a position on the operation path that is closest to the current position of the agricultural machine.

After determining the starting position of the agricultural machine when it is operating, the agricultural machine can move from the starting position along the operation path and perform the operation, and hence the automatic operation can be realized.

The current position information of the agricultural machine can be input by the user or obtained automatically by the agricultural machine. In some embodiments, the current position information of the agricultural machine is input by the user through the input device of the agricultural machine, thereby meeting the specific needs of the user, which is convenient and fast. In some embodiments, the input device may be a touch screen, a button, or other types of input device, and the user informs the agricultural machine of its current position information by directly operating the touch screen, the button, or the other types of input device.

In some other embodiments, the current position information of the agricultural machine is automatically acquired by the agricultural machine, and the acquired current position can have a higher accuracy. The agricultural machine can include a navigation device, such as navigation device 300 shown in FIG. 6, which can include a real-time kinematic (RTK) device, such as RTK device 310 shown in FIG. 8. In these embodiments, acquiring the current position information of the agricultural machine includes acquiring the current position information of the agricultural machine through the navigation device 300 of the agricultural machine, where the navigation device 300 can be a positioning device mounted on the agricultural machine, a Global Positioning System (GPS) device of the agricultural machine, or the RTK device 310. The specific type of the navigation device 300 can be selected according to needs, so as to meet different operation efficiencies.

In this embodiment, the geographic information of the area to be operated is recorded by the user. Specifically, the user can carry a recording device and walk around the edge of the area to be operated. During the walking, a positioning device (e.g., GPS) that comes with the recording device performs a real-time positioning or a periodic positioning to the boundary points of the area to be operated. After the user carrying the recording device walks a cycle along the edge of the area to be operated, the recording device will obtain the position information of a large number of boundary points in the area to be operated. As shown in FIG. 2, 1 indicates the area to be operated, and 10 indicates the boundary points. The position information of each boundary point includes longitude information and latitude information. A boundary of the area to be operated can be determined based on the position information of the large number of boundary points. The recording device may be a smart terminal e.g., a mobile phone, a remote controller, a smart bracelet, a tablet computer, head-mounted display glasses (VR glasses, VR helmets, etc.), etc.

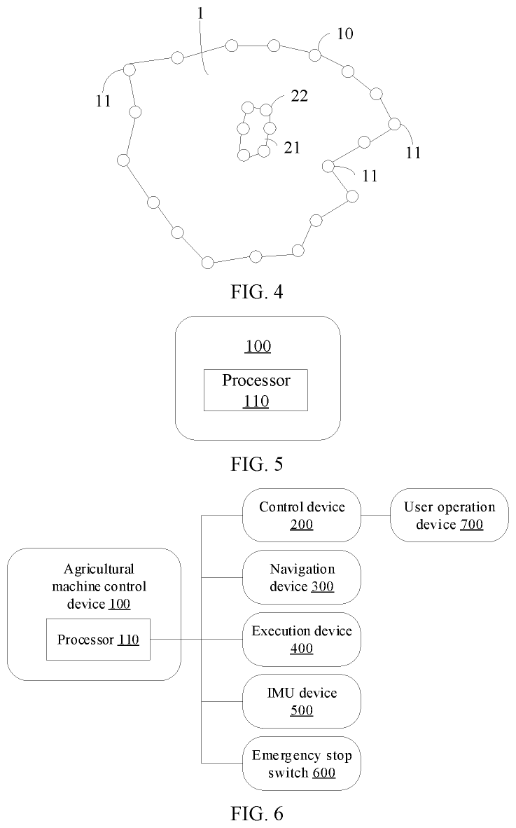

In some embodiments, obstacles exist in the area to be operated and need to be recorded. Specifically, the user can carry a recording device to walk inside the operation area. When an obstacle, e.g., a tree, a large stone, a pond, etc., is found, the position of the obstacle (indicated by 20 in FIG. 3) or the boundary point (indicated by 22 in FIG. 4) of the obstacle area (indicated by 21 in FIG. 4) can be recorded by the recording device.

In some embodiments, the agricultural machine can acquire the geographic information of the area to be operated according to one of the following example methods.

In some embodiments, position information of the boundary points of the area to be operated is acquired.

As shown in FIG. 2, the recording device can determine the geographical information of the boundary of the area to be operated according to the position information of each boundary point of the area to be operated. The geographical information may specifically be a geographic location, e.g., latitude and longitude information.

Further, acquiring the position information of the boundary points of the area to be operated includes acquiring key points on the boundary of the area to be operated, where the key points include at least one of a corner position or a non-linear position. As shown in FIG. 2, the boundary point 11 has a larger turning angle than other boundary points, and the boundary line cannot smoothly transit at the boundary point 11, in which case such a boundary point 11 is a key point. When the user walks along the boundary of the area to be operated with the recording device, if a key point is found, the key point can be marked to distinguish it from other boundary points.

Determining an operation path of an agricultural machine according to geographic information and current position information of the agricultural machine includes determining the terrain information of the boundary of the operation area of the agricultural machine according to the position information of the key point. The terrain such as steep slopes, terraces, etc. of the area to be operated is determined using the position information of the key points.

In some embodiments, the position information of the obstacles in the area to be operated is acquired, or, the position information of the boundary points of the obstacle area in the area to be operated is acquired. As shown in FIG. 3, 20 indicates an obstacle point in the area to be operated. The geographic information of the obstacle in the area to be operated can be obtained according to the obstacle point 20. As shown in FIG. 4, 21 indicates an obstacle area in the area to be operated, and 22 indicates a boundary point of the obstacle area in the area to be operated. The geographic information of the obstacle area 21 in the area to be operated can be obtained according to the position information of the boundary point 22 of each obstacle area. The geographic information of the obstacle area 21 may be the latitude and longitude range occupied by the obstacle area 21.

At S102, the agricultural machine is controlled to perform an operation in the automatic operation mode according to the control information.

In this embodiment, the user may specify a position as a preset position that may be used to calibrate the positioning deviation of the agricultural machine. When the area to be operated is large, because the agricultural machine can load a fixed amount of pesticide or seeds each time, pesticides loaded by the agricultural machine at one time cannot cover the entire area to be operated, or seeds loaded by the agricultural machine at one time cannot cover the entire area to be operated, and multiple loads and operations are needed. If there is a deviation in the driving position of the agricultural machine, it will cause the agricultural machine to be unable to accurately locate the place where it left before, which causes the agricultural machine to repeat the operation of a specific area or miss the operation of a specific area in the area to be operated, and hence cause loss to the user. In order to calibrate the positioning deviation of the agricultural machine, when surveying and mapping the area to be operated, the user can specify one or more points in the area to be operated as the preset position and record the positioning information of the preset position in the recording device, thereby determine the positioning information of the preset position as a reference.

In some embodiments, the control information may further include position calibration information that includes a preset position and positioning information corresponding to the preset position, so as to calibrate the real-time position of the agricultural machine during the operation of the agricultural machine to ensure the accuracy of the real-time position of the agricultural machine, and hence ensure the accuracy of the operation of the agricultural machine. Specifically, the controlling the agricultural machine to perform an operation in the automatic operation mode according to the control information may include calibrating the real-time position of the agricultural machine according to the calibration information.

Further, calibrating the real-time position of the agricultural machine according to the calibration information may further include: acquiring the position information of the preset position detected by the agricultural machine when the agricultural machine is located at the preset position; and calibrating the positioning deviation of the agricultural machine according to the positioning information of the preset position and the position information of the preset position detected by the agricultural machine, and hence ensure the continuity and accuracy of the operation of the agricultural machine. The agricultural machine may send a calibration instruction to the corresponding control device 200 (e.g., steering control device 210) of the agricultural machine after determining that the agricultural machine has a positioning deviation according to the positioning information of the preset position and the position information of the preset position detected by the agricultural machine, to enable the agricultural machine to calibrate its own positioning deviation.

At S103, if it is determined that the agricultural machine is in an abnormal status, an interrupt signal is sent to the agricultural machine, so as to cause the agricultural machine to stop moving and stop a relevant operation.

Specifically, whether the agricultural machine is in an abnormal status can be determined according to the comparison result between the actual path of the agricultural machine and the operation path obtained at S101, or according to the operation status of each of the devices on the agricultural machine. In some embodiments, whether the agricultural machine is in an abnormal status is determined according to the comparison result between the actual path of the agricultural machine and the operation path obtained at S101. When the difference between the actual path and the operation path is greater than or equal to the preset difference value, if the agricultural machine does not stop moving and operating, the agricultural machine may be caused to operate in areas where no operation is required, resulting in waste of resources and user losses. In this embodiment, a specific implementation method for determining whether the agricultural machine is in an abnormal status according to the comparison result between the actual path and the operation path may include the following.

In one embodiment, it is determined that the actual path of the agricultural machine deviates from the operation path, and the deviation of the actual path from the operation path is greater than or equal to a preset deviation, and then it is determined that the agricultural machine is in an abnormal status. Specifically, the deviation of the actual path from the operation path may be the minimum distance between the current position and the operation path of the agricultural machine. When the agricultural machine determines that the actual path of the agricultural machine deviates from the operation path, but the deviation of the actual path from the operation path is less than the preset deviation, it is indicated that the error of the actual path of the agricultural machine is within an allowable error range, and stopping the agricultural machine to move and operate is not needed.

The value of the preset deviation can be set as needed. In one embodiment, the preset deviation is 0.5 m (unit: meter). When the deviation between the actual path of the agricultural machine and the operation path is greater than or equal to 0.5 m, it indicates that the deviation of the actual path of the agricultural machine is large and a continuous operation will lead to waste of resources and user losses.

In another embodiment, it is determined that the coincidence degree of the actual path of the agricultural machine and the operation path is less than or equal to a preset coincidence degree, and then it is determined that the agricultural machine is in an abnormal status. The value of the preset coincidence degree can be set as needed. In one embodiment, the preset coincidence degree is 95%. When the coincidence degree of the actual path of the agricultural machine and the operation path is less than or equal to 95%, it is indicated that the deviation of the actual path of the agricultural machine is large and a continuous operation will lead to waste of resources and user losses.

After determining that the agricultural machine is in an abnormal status, the agricultural machine can be suspended to continue to move forward and operate, thereby preventing waste of resources and ensuring the safety of the operation of the agricultural machine.

In this embodiment, the deviation of the actual path of the agricultural machine being large can further include the following.

When the actual path of the agricultural machine is in the same geographical area as the area to be operated, for example, the area to be operated is located in geographical area A, and the actual path of the agricultural machine is also located in geographical area A, but the actual path deviates from the operation path relatively largely or the coincidence degree of the actual path and the operation path is relatively small, it is determined that the deviation of the actual path of the agricultural machine is large.

When the area where the actual path of the agricultural machine is located and the area to be operated are located in different geographical areas, it can be directly determined that the deviation of the actual path of the agricultural machine is large. For example, the area to be operated is located in geographical area A, but the actual path of the agricultural machine is located in geographical area B, and A and B are two different areas.

In some other embodiments, whether the agricultural machine is in an abnormal status is determined according to the operation status of various devices of the agricultural machine. As shown in FIG. 6, an agricultural machine includes a control device 200, a navigation device 300, and an execution device 400. The control device 200 is configured to control the operation of the agricultural machine, e.g., the direction and speed of the agricultural machine. Specifically, the agricultural machine further includes a user operation device 700. The control device 200 is connected to the user operation device 700 to control the operation of the user operation device 700. As shown in FIG. 7, the user operation device 700 includes a steering wheel 710, a brake pedal 720, and an accelerator pedal 730. The control device 200 includes at least one of a steering control device 210, an accelerator control device, or a brake control device 220, but is not limited thereto. The brake control device 220 is connected to the steering wheel 710 to control the operation of the steering wheel 710 to control the steering of the agricultural machine. The brake control device 220 is connected to the brake pedal 720 to control the operation of the brake pedal 720 to control the deceleration of the agricultural machine. The accelerator control device 230 is connected to the accelerator pedal 730 to control the operation of the accelerator pedal 730 to control the acceleration of the agricultural machine.

Further, a torque sensor 711 is provided at the steering wheel 710 to detect the torque of the steering wheel 710. A first pressure sensor 721 is provided at the brake pedal 720 to detect the pressure of the brake pedal 720. A second pressure sensor 731 is provided at the accelerator pedal 730 to detect the pressure of the accelerator pedal 730.

The navigation device 300 is configured to determine the position information of the agricultural machine. As shown in FIG. 8, the navigation device 300 includes an RTK device 310, which can locate the agricultural machine more accurately. The navigation device 300 may also include a GPS device, and the RTK device 310 can coordinate with the GPS device to achieve precise positioning of the agricultural machine.

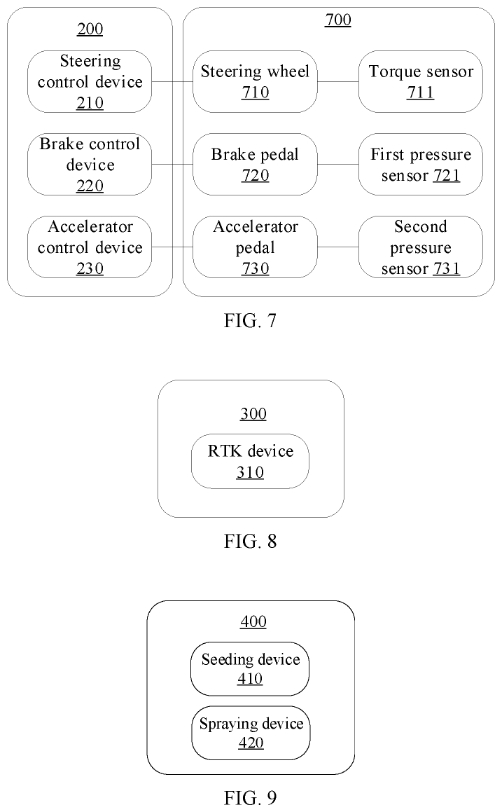

The execution device 400 is configured to perform spraying, seeding operations, etc. As shown in FIG. 9, the execution device 400 includes at least one of a seeding device 410 or a spraying device 420, but is not limited thereto. The seeding function is implemented through the seeding device 410, and the pesticide spraying function is implemented through the spraying device 420. In some embodiments, the seeding device 410 and the spraying device are the same device, and can implement the functions of seeding and spraying pesticides in the area to be operated at different times. In other embodiments, the seeding device 410 and the spraying device 420 are two independent devices, which can implement the function of seeding and spraying pesticides in the area to be operated at the same time or at different times.

In some embodiments, as shown in FIG. 6, the agricultural machine further includes an inertial measurement unit (IMU) device 500. The attitude of the seeding device 410 or the spraying device 420 of the agricultural machine is detected through the IMU device 500, so that the attitude of the seeding device 410 or the spraying device 420 can be adjusted according to the result of the attitude detection to ensure the accuracy of the position of the seeding device 410 or the spraying device 420.

In some embodiments, the implementation method for determining whether the agricultural machine is in an abnormal status may include the following.

In one embodiment, determining that the agricultural machine is in an abnormal status includes detecting that a communication link of any device of the agricultural machine is disconnected and the duration of the disconnection is greater than or equal to a preset first duration. The device may include at least one of the control device 200, the navigation device 300, or the execution device 400, but is not limited thereto. For example, the device may further include other functional devices. Specifically, the agricultural machine can detect the link flag bit of any of the devices described above in real time. If the link flag bit indicates that the corresponding device is in a communication link disconnected status, the duration that the corresponding device is in the communication link disconnected status is counted. If the duration is greater than or equal to the preset first duration, it is indicated that the link of the corresponding device is broken. On the other hand, if the duration is less than the preset first duration, it is indicated that the corresponding device has resumed communication and it is in a normal status.

The time length of the first duration can be set as needed, e.g., 50 s (unit: second), 60 s, etc.

In another embodiment, after controlling the agricultural machine to perform the operation in the automatic operation mode, the method may further include receiving parameters fed back from various functional devices of the agricultural machine, where the functional device includes at least core sensor devices, e.g., the RTK device 310, and the IMU device 500, etc. Determining that the agricultural machine is in an abnormal status includes detecting that a parameter fed back from any functional device is an invalid parameter. Whether the agricultural machine is in an abnormal status can be determined by detecting the validity of the parameters fed back from various functional devices. A valid parameter and an invalid parameter of each functional device can be set in advance.

In another embodiment, determining that the agricultural machine is in an abnormal status includes detecting that a control error generated by the control device 200 of the agricultural machine is greater than or equal to a preset error value and the duration of the control device 200 generating the control error is greater than or equal to a preset second duration. The control error generated by the control device 200 may include at least one of the steering deviation generated when the steering control device 210 of the agricultural machine controls the steering of the steering wheel 710 (i.e., the difference between the actual steering of the steering wheel 710 and a preset steering), the speed deviation generated when the accelerator control device 230 of the agricultural machine controls the accelerator pedal 730 (i.e., the difference between the actual acceleration of the agricultural machine controlled by the accelerator pedal 730 and the preset acceleration), or the speed deviation generated when the brake control device 220 of the agricultural machine controls the brake pedal 720 (i.e., the difference between the actual deceleration of the agricultural machine controlled by the brake pedal 720 and the preset deceleration), but is not limited thereto.

The preset error value can be set according to the accuracy requirement. The time length of the second duration can be set as needed, e.g., 50 s, 60 s, etc.

In addition, the operation may include at least one of the seeding operation or the spraying operation, but is not limited thereto.

In the present disclosure, when an abnormal status occurs in the agricultural machine, an interruption signal is sent to the agricultural machine to control the agricultural machine to stop moving and the relevant operation, making the agricultural machine have automatic protection measures, improving the safety of automatic operation of the agricultural machine, and enhancing the timeliness of the automatic protection of the agricultural machine. The function of the automatic protection of the agricultural machine further saves human resources.

In another embodiment, after controlling the agricultural machine to perform the operation in the automatic operation mode, the method may further include acquiring current status information of the user operation device 700 of the agricultural machine. When it is determined that the agricultural machine is in a manual intervention status according to the status information of the user operation device 700, the agricultural machine is switched from the automatic operation mode to the manual operation mode. In this embodiment, the priority of the manual operation mode is set higher than the priority of the automatic operation mode, and the design is more user friendly. The status information of the user operation device 700 may include at least one of the torque of the steering wheel 710 of the agricultural machine, the pressure of the brake pedal 720 of the agricultural machine, or the pressure of the accelerator pedal 730 of the agricultural machine, but is not limited thereto.

Determining whether the agricultural machine is in a manual intervention status may include the following.

In some embodiments, when the status information of the user operation device 700 is the torque of the steering wheel 710 of the agricultural machine, determining that the agricultural machine is in a manual intervention status according to the status information of the user operation device 700 includes determining that the agricultural machine is in a manual intervention status when the torque of the steering wheel 710 is greater than or equal to a preset torque value. When the agricultural machine is in the manual control status, the steering wheel 710 is manually controlled to rotate, so that the steering wheel 710 drives the wheels of the agricultural machine to turn. On the other hand, when the agricultural machine is in the automatic operation mode, the wheels of the agricultural machine drive the steering wheel 710 to rotate. The torque of the steering wheel 710 during the steering wheel 710 driving the wheel to turn is greater than the torque of the steering wheel 710 during the wheel driving the steering wheel 710 to rotate. Therefore, it can be determined whether the steering wheel 710 is under manual control or wheel control according to the torque of the steering wheel 710.

In some embodiments, when the status information of the user operation device 700 is the pressure of the brake pedal 720 of the agricultural machine, determining that the agricultural machine is in a manual intervention status according to the status information of the user operation device 700 includes determining that the agricultural machine is in a manual intervention state when the pressure of the brake pedal 720 is greater than a first preset pressure value. Specifically, when the agricultural machine is in the manual control status, the first pressure sensor 721 on the brake pedal 720 outputs a first signal. When the agricultural machine is in the automatic operation mode, the first pressure sensor 721 on the brake pedal 720 outputs a second signal. The first signal is different from the second signal, so that the first signal and the second signal can be used to determine whether the agricultural machine is in the manual control status or the automatic operation mode. In this embodiment, when the second signal is approximately 0 (i.e., the value output by the first pressure sensor 721 when the first pressure sensor 721 does not detect the signal), it is indicated that the agricultural machine is in the automatic operation mode, and the first preset pressure value is equal to 0. On the other hand, when the first signal is greater than 0, it is indicated that the brake pedal 720 of the agricultural machine is in the manual control status. Correspondingly, the agricultural machine is in the manual control status, and the agricultural machine needs to be switched from the automatic operation mode to the manual operation mode.

In some embodiments, when the status information of the user operation device 700 is the pressure of the accelerator pedal 730 of the agricultural machine, determining that the agricultural machine is in a manual intervention status according to the status information of the user operation device 700 includes determining that the agricultural machine is in a manual intervention state when the pressure of the accelerator pedal 730 is greater than a second preset pressure value. Specifically, when the agricultural machine is in the manual control status, the second pressure sensor 731 on the accelerator pedal 730 outputs a third signal. When the agricultural machine is in the automatic operation mode, the second pressure sensor 731 on the accelerator pedal 730 outputs a fourth signal. The third signal is different from the fourth signal, so that the third signal and the fourth signal can be used to determine whether the agricultural machine is in the manual control status or the automatic operation mode. In this embodiment, when the fourth signal is approximately 0 (i.e., the value output by the second pressure sensor 731 when the second pressure sensor 731 does not detect the signal), it is indicated that the agricultural machine is in the automatic operation mode, and the second preset pressure value is equal to 0. On the other hand, when the third signal is greater than 0, it is indicated that the accelerator pedal 730 of the agricultural machine is in the manual control status. Correspondingly, the agricultural machine is in the manual control status, and the agricultural machine needs to be switched from the automatic operation mode to the manual operation mode.

In some embodiments, after controlling the agricultural machine to perform the operation in the automatic operation mode, the method may further include controlling the agricultural machine to stop moving and the relevant operation upon receiving a stop instruction sent by a user side. As shown in FIG. 6, the agricultural machine further includes an emergency stop switch 600 for controlling whether the agricultural machine works, which may include the moving and operation of the agricultural machine. In this embodiment, the stop instruction is sent by the emergency stop switch 600. Specifically, during the operation of the agricultural machine, when the actual path of the agricultural machine deviates from the operation path, the user can press the emergency stop switch 600, and the agricultural machine can control itself to stop moving and the relevant operation (i.e., the current operation) by cutting off the power.

As shown in FIG. 5, an embodiment of the present disclosure provides a device for controlling an agricultural machine 100 including a processor 110 (e.g., a single or multi-core processor 110).

In this embodiment, the processor 110 may include one or more processors, which work individually or together for implementing the processes of the agricultural machine control method according to the embodiments described above.

As shown in FIG. 6, the processor 110 is communicatively connected with the control device 200, the navigation device 300, the execution device 400, the IMU device 500, and the emergency stop switch 600 of the agricultural machine, so that the communication link status of the control device 200, the navigation device 300, the execution device 400, the IMU device 500, etc., the validity of the feedback parameters, or the control error can be obtained in time. Whether to implement automatic interruption protection measures for the agricultural machine can be then determined according to the information of the status of communication links, the validity of feedback parameters, or control errors, to ensure the safety of the operation of the agricultural machine. Further, after receiving the stop instruction sent by the emergency stop switch 600, the processor 110 can immediately stop moving and the relevant operation of the agricultural machine. The agricultural machine control device 100 can be further described with reference to the agricultural machine control method in the embodiments described above, and will not be repeated here.

An embodiment of the present disclosure provides a computer storage medium storing program instructions, and the execution of the program implements the agricultural machine control method described above.

As shown in FIG. 6, an embodiment of the present disclosure provides an agricultural machine control system including an agricultural machine (not shown in the figure) and the agricultural machine control device 100 provided at the agricultural machine. In some embodiments, the agricultural machine includes a machine body, and the agricultural machine control device 100 is disposed in the machine body.

In some embodiments, the agricultural machine control device 100 includes one or more processors 110 (e.g., a single or multi-core processor 110), which work individually or together.

Specifically, the processor 110 is configured to acquire the control information of the automatic operation mode, and control the agricultural machine to perform the operation in the automatic operation mode according to the control information. When the processor 110 determines that the agricultural machine is in an abnormal status, it sends an interrupt signal to the agricultural machine to stop moving and the relevant operation of the agricultural machine. The control information includes at least an operation path of the agricultural machine.

In the present disclosure, when an abnormal status occurs in the agricultural machine, an interruption signal is sent to the agricultural machine to control the agricultural machine to stop moving and the relevant operation, making the agricultural machine have automatic protection measures, improving the safety of automatic operation of the agricultural machine, and enhancing the timeliness of the automatic protection of the agricultural machine. The function of the automatic protection of the agricultural machine further saves human resources.

The operation may include at least one of the seeding operation or the spraying operation, but is not limited thereto.

The control information is input by a user, so that the operation path can be generated according to the need of the user, which is convenient and fast. Specifically, the agricultural machine control system further includes an input device (not shown) provided at the agricultural machine, and the input device is communicatively connected with the processor 110. The processor 110 acquires the geographical information of the area to be operated through an input device of the agricultural machine, where the input device may be a touch screen, a button, or another type. In some embodiments, the input device may be a touch screen, and the processor 110 acquires the geographical information of the area to be operated through the operation of the user on the touch screen.

In some other embodiments, the input device may be a button, and the processor 110 acquires the geographical information of the area to be operated through the operation of the user on the button.

The processor 110 may be configured to acquire geographic information of the area to be operated and current position information of the agricultural machine, and determine an operation path of the agricultural machine according to the geographic information and the current position information of the agricultural machine. The current position information of the agricultural machine can be used to determine a starting position of the agricultural machine when it is operating. Determining the starting position can include: when the current position of the agricultural machine is on the determined operation path, the starting position may be the current position of the agricultural machine; when the current position of the agricultural machine is not on the determined operation path, the starting position may be a position determined according to the current position of the agricultural machine and the operation path, e.g., a position on the operation path that is closest to the current position of the agricultural machine.

After determining the starting position of the agricultural machine when it is operating, the agricultural machine can move from the starting position along the operation path and perform the operation, and hence the automatic operation requirements can be realized.

The current position information of the agricultural machine can be input by the user or obtained automatically by the agricultural machine. In some embodiments, the current position information of the agricultural machine is input by the user through the input device of the agricultural machine, thereby meeting the specific needs of the user, which is convenient and fast. In some embodiments, the input device may be a touch screen, a button, or other types of input device, and the user informs the processor 110 of the current position information of the agricultural machine by directly operating the touch screen, the button, or the other types of input device.

In some other embodiments, the current position information of the agricultural machine is automatically acquired by the agricultural machine, and the acquired current position can have a higher accuracy. Specifically, the agricultural machine control system further includes a navigation device 300 provided at the agricultural machine, and the navigation device 300 is communicatively connected with the processor 110. The processor 110 acquiring the current position information of the agricultural machine includes acquiring the current position information of the agricultural machine through the navigation device 300 of the agricultural machine, where the navigation device 300 can be a positioning device mounted on the agricultural machine, a Global Positioning System (GPS) device of the agricultural machine, or a real-time kinematic (RTK) device 310. The specific type of the navigation device 300 can be selected according to needs, so as to meet different operation efficiencies.

In this embodiment, the geographic information of the area to be operated is recorded by the user. Specifically, the user can carry a recording device and walk around the edge of the area to be operated. During the walking, a positioning device (e.g., GPS) that comes with the recording device performs a real-time positioning or a periodic positioning to the boundary points of the area to be operated. After the user carrying the recording device walks a cycle along the edge of the area to be operated, the recording device will obtain the position information of a large number of boundary points in the area to be operated. As shown in FIG. 2, 1 indicates the area to be operated, and 10 indicates the boundary points. The position information of each boundary point includes longitude information and latitude information. A boundary of the area to be operated can be determined based on the position information of the large number of boundary points. The recording device may be a smart terminal e.g., a mobile phone, a remote controller, a smart bracelet, a tablet computer, head-mounted display glasses (VR glasses, VR helmets, etc.), etc.

In some embodiments, obstacles exist in the area to be operated and need to be recorded. Specifically, the user can carry a recording device to walk inside the operation area. When an obstacle, e.g., a tree, a large stone, a pond, etc., is found, the position of the obstacle (indicated by 20 in FIG. 3) or the boundary point (indicated by 22 in FIG. 4) of the obstacle area (indicated by 21 in FIG. 4) can be recorded by the recording device.

In some embodiments, the geographic information of the area to be operated includes position information of the boundary points of the area to be operated. As shown in FIG. 2, the recording device can determine the geographical information of the boundary of the area to be operated according to the position information of each boundary point of the area to be operated. The geographical information may specifically be a geographic location, e.g., latitude and longitude information.

Further, acquiring the position information of the boundary points of the area to be operated includes acquiring key points on the boundary of the area to be operated, where the key points include at least one of a corner position or a non-linear position. As shown in FIG. 2, the boundary point 11 has a larger turning angle than other boundary points, and the boundary line cannot smoothly transit at the boundary point 11, in which case such a boundary point 11 is a key point. When the user walks along the boundary of the area to be operated with the recording device, if a key point is found, the key point can be marked to distinguish it from other boundary points.

In some embodiments, the processor 110 is configured to determine the terrain information of the boundary of the operation area of the agricultural machine according to the position information of the key point. The terrain such as steep slopes, terraces, etc. of the area to be operated is determined using the position information of the key points.

In some other embodiments, the geographic information of the area to be operated includes the position information of the obstacles in the area to be operated, or, the position information of the boundary points of the obstacle area in the area to be operated. As shown in FIG. 3, 20 indicates an obstacle point in the area to be operated. The geographic information of the obstacle in the area to be operated can be obtained according to the obstacle point 20. As shown in FIG. 4, 21 indicates an obstacle area in the area to be operated, and 22 indicates a boundary point of the obstacle area in the area to be operated. The geographic information of the obstacle area 21 in the area to be operated can be obtained according to the position information of the boundary point 22 of each obstacle area. The geographic information of the obstacle area 21 may be the latitude and longitude range occupied by the obstacle area 21.

In some embodiments, the user may specify a position as a preset position that may be used to calibrate the positioning deviation of the agricultural machine. When the area to be operated is large, because the agricultural machine can load a fixed amount of pesticide or seeds each time, pesticides loaded by the agricultural machine at one time cannot cover the entire area to be operated, or seeds loaded by the agricultural machine at one time cannot cover the entire area to be operated, and multiple loads and operations are needed. If there is a deviation in the driving position of the agricultural machine, it will cause the agricultural machine to be unable to accurately locate the place where it left before, which causes the agricultural machine to repeat the operation of a specific area or miss the operation of a specific area in the area to be operated, and hence cause loss to the user. In order to calibrate the positioning deviation of the agricultural machine, when surveying and mapping the area to be operated, the user can specify one or more points in the area to be operated as the preset position and record the positioning information of the preset position in the recording device, thereby determine the positioning information of the preset position as a reference.

In some embodiments, the control information may further include the position calibration information that includes a preset position and positioning information corresponding to the preset position, so as to calibrate the real-time position of the agricultural machine during the operation of the agricultural machine to ensure the accuracy of the real-time position of the agricultural machine, and hence ensure the accuracy of the operation of the agricultural machine. The processor 110 is configured to calibrate the real-time position of the agricultural machine according to the calibration information.

Further, the processor 110 is configured to acquire the position information of the preset position detected by the agricultural machine when the agricultural machine is located at the preset position, and calibrate the positioning deviation of the agricultural machine according to the positioning information of the preset position and the position information of the preset position detected by the agricultural machine, and hence ensure the continuity and accuracy of the operation of the agricultural machine. The processor 110 may send a calibration instruction to the corresponding control device 200 (e.g., steering control device 210) of the agricultural machine after determining that the agricultural machine has a positioning deviation according to the positioning information of the preset position and the position information of the preset position detected by the agricultural machine, to calibrate the positioning deviation of the agricultural machine.

In some embodiments, the processor 110 may determine whether the agricultural machine is in an abnormal status according to the comparison result between the actual path of the agricultural machine and the operation path in the control information, or according to the operation status of each of the devices on the agricultural machine. In some embodiments, the processor 110 determines whether the agricultural machine is in an abnormal status according to the comparison result between the actual path of the agricultural machine and the operation path. When the difference between the actual path and the operation path is greater than or equal to the preset difference value, if the agricultural machine does not stop moving and operating, the agricultural machine may be caused to operate in areas where no operation is required, resulting in waste of resources and user losses. In this embodiment, a specific implementation method for the processor 110 determining whether the agricultural machine is in an abnormal status according to the comparison result between the actual path and the operation path may include the following.

In one embodiment, when the processor 110 determines that the actual path of the agricultural machine deviates from the operation path, and the deviation of the actual path from the operation path is greater than or equal to a preset deviation, it is determined that the agricultural machine is in an abnormal status. Specifically, the deviation of the actual path from the operation path may be the minimum distance between the current position and the operation path of the agricultural machine. When the processor 110 determines that the actual path of the agricultural machine deviates from the operation path, but the deviation of the actual path from the operation path is less than the preset deviation, it is indicated that the error of the actual path of the agricultural machine is within an allowable error range, and stopping the agricultural machine to move and operate is not needed.

The value of the preset deviation can be set as needed. In one embodiment, the preset deviation is 0.5 m (unit: meter). When the deviation between the actual path of the agricultural machine and the operation path is greater than or equal to 0.5 m, it indicates that the deviation of the actual path of the agricultural machine is large and a continuous operation will lead to waste of resources and user losses.

In another embodiment, when the processor 110 determines that the coincidence degree of the actual path of the agricultural machine and the operation path is less than or equal to a preset coincidence degree, it is determined that the agricultural machine is in an abnormal status. The value of the preset coincidence degree can be set as needed. In one embodiment, the preset coincidence degree is 95%. When the coincidence degree of the actual path of the agricultural machine and the operation path is less than or equal to 95%, it is indicated that the deviation of the actual path of the agricultural machine is large and a continuous operation will lead to waste of resources and user losses.

After determining that the agricultural machine is in an abnormal status, the processor 110 may suspend the agricultural machine to continue to move forward and operate, thereby preventing waste of resources and ensuring the safety of the operation of the agricultural machine.

In this embodiment, the deviation of the actual path of the agricultural machine being large can further include the following.

When the actual path of the agricultural machine is in the same geographical area as the area to be operated, for example, the area to be operated is located in geographical area A, and the actual path of the agricultural machine is also located in geographical area A, but the actual path deviates from the operation path relatively largely or the coincidence degree of the actual path and the operation path is relatively small, it is determined that the deviation of the actual path of the agricultural machine is large.

When the area where the actual path of the agricultural machine is located and the area to be operated are located in different geographical areas, it can be directly determined that the deviation of the actual path of the agricultural machine is large. For example, the area to be operated is located in geographical area A, but the actual path of the agricultural machine is located in geographical area B, and A and B are two different areas.

As shown in FIG. 6, the agricultural machine control system further includes a control device 200, a navigation device 300, and an execution device 400 provided at the agricultural machine and communicatively connected to the processor 110. The control device 200 is configured to control the operation of the agricultural machine, e.g., the direction and speed of the agricultural machine. Specifically, the agricultural machine further includes a user operation device 700. The control device 200 is connected to the user operation device 700 to control the operation of the user operation device 700.

As shown in FIG. 7, the user operation device 700 includes a steering wheel 710, a brake pedal 720, and an accelerator pedal 730 provided at the agricultural machine. The control device 200 includes at least one of a steering control device 210, an accelerator control device, or a brake control device 220, but is not limited thereto. The brake control device 220 is connected to the steering wheel 710 to control the operation of the steering wheel 710 to control the steering of the agricultural machine. The brake control device 220 is connected to the brake pedal 720 to control the operation of the brake pedal 720 to control the deceleration of the agricultural machine. The accelerator control device 230 is connected to the accelerator pedal 730 to control the operation of the accelerator pedal 730 to control the acceleration of the agricultural machine.

The user operation device 700 may further include a torque sensor 711 provided at the steering wheel 710, a first pressure sensor 721 provided at the brake pedal 720, and a second pressure sensor 731 provided at the accelerator pedal 730. The torque sensor 711, the first pressure sensor 721, and the second pressure sensor 731 are all electrically connected to the processor 110. The torque sensor 711 is configured to detect the torque of the steering wheel 710 and send it to the processor 110. The first pressure sensor 721 is configured to detect the pressure of the brake pedal 720 and send it to the processor 110. The second pressure sensor 731 is configured to detect the pressure of the accelerator pedal 730 and send it to the processor 110.

The navigation device 300 is configured to determine the position information of the agricultural machine. As shown in FIG. 8, the navigation device 300 includes an RTK device 310, which can locate the agricultural machine more accurately. The navigation device 300 may also include a GPS device, and the RTK device 310 can coordinate with the GPS device to achieve precise positioning of the agricultural machine.

The execution device 400 is configured to perform spraying, seeding operations, etc. As shown in FIG. 9, the execution device 400 includes at least one of a seeding device 410, or a spraying device 420, but is not limited thereto. The seeding function is implemented through the seeding device 410, and the pesticide spraying function is implemented through the spraying device 420. In some embodiments, the seeding device 410 and the spraying device are the same device, and can implement the functions of seeding and spraying pesticides in the area to be operated at different times. In other embodiments, the seeding device 410 and the spraying device 420 are two independent devices, which can implement the function of seeding and spraying pesticides in the area to be operated at the same time or at different times.

In some embodiments, as shown in FIG. 6, the agricultural machine further includes an inertial measurement unit (IMU) device 500. The attitude of the seeding device 410 or the spraying device 420 of the agricultural machine is detected through the IMU device 500, so that the attitude of the seeding device 410 or the spraying device 420 can be adjusted according to the result of the attitude detection to ensure the accuracy of the position of the seeding device 410 or the spraying device 420.

In some embodiments, the implementation method for the processor 110 to determine whether the agricultural machine is in an abnormal status may include the following.

In some embodiments, the processor 110 may determine whether the agricultural machine is in an abnormal status according to the operation status of various devices of the agricultural machine. Specifically, when the processor 110 detects that the communication link of any of the control device 200, the navigation device 300, or the execution device 400 is disconnected and the duration of the disconnection is greater than or equal to a preset first duration, it is determined that the agricultural machine is in an abnormal status. Specifically, the processor 110 can detect the link flag bit of any of the devices described above in real time. If the link flag bit indicates that the corresponding device is in a communication link disconnected status, the duration that the corresponding device is in the communication link disconnected status is counted. If the duration is greater than or equal to the preset first duration, it is indicated that the link of the corresponding device is broken. On the other hand, if the duration is less than the preset first duration, it is indicated that the corresponding device has resumed communication and it is in a normal status.

The time length of the first duration can be set as needed, e.g., 50 s (unit: second), 60 s, etc.

In another embodiment, the agricultural machine control system further includes a functional device provided at the agricultural machine, where the functional device may include at least one of the RTK device 310 or the IMU device 500. The processor 110 may be further configured to receive the parameter fed back from the functional device of the agricultural machine, and determine that the agricultural machine is in an abnormal status when detecting that the parameter fed back from the functional device is an invalid parameter. Whether the agricultural machine is in an abnormal status can be determined by detecting the validity of the parameters fed back from various functional devices. A valid parameter and an invalid parameter of each functional device can be set in advance.

In another embodiment, the processor 110 is further configured to determine that the agricultural machine is in an abnormal status when it is detected that the control error generated by the control device 200 of the agricultural machine is greater than or equal to a preset error value, and the duration of the control device 200 generating the control error is greater than or equal to a preset second duration. The control error generated by the control device 200 may include at least one of the steering deviation generated when the steering control device 210 of the agricultural machine controls the steering of the steering wheel 710 (i.e., the difference between the actual steering of the steering wheel 710 and a preset steering), the speed deviation generated when the accelerator control device 230 of the agricultural machine controls the accelerator pedal 730 (i.e., the difference between the actual acceleration of the agricultural machine controlled by the accelerator pedal 730 and the preset acceleration), or the speed deviation generated when the brake control device 220 of the agricultural machine controls the brake pedal 720 (i.e., the difference between the actual deceleration of the agricultural machine controlled by the brake pedal 720 and the preset deceleration), but is not limited thereto.

The preset error value can be set according to the accuracy requirement. The time length of the second duration can be set as needed, e.g., 50 s, 60 s, etc.

In some embodiments, the processor 110 may be further configured to acquire current status information of the user operation device 700 of the agricultural machine after controlling the agricultural machine to perform the operation in the automatic operation mode, and switch the agricultural machine from the automatic operation mode to the manual operation mode when it is determined that the agricultural machine is in a manual intervention status according to the status information of the user operation device 700. In this embodiment, the priority of the manual operation mode is set higher than the priority of the automatic operation mode, and the design is more user friendly. The status information of the user operation device 700 may include at least one of the torque of the steering wheel 710 of the agricultural machine, the pressure of the brake pedal 720 of the agricultural machine, or the pressure of the accelerator pedal 730 of the agricultural machine, but is not limited thereto.

Determining whether the agricultural machine is in a manual intervention status may include the following.

In some embodiments, it is determined that the agricultural machine is in a manual intervention status when the processor 110 detects that the torque detected by the torque sensor 711 is greater than or equal to a preset torque value. When the agricultural machine is in the manual control status, the steering wheel 710 is manually controlled to rotate, so that the steering wheel 710 drives the wheels of the agricultural machine to turn. On the other hand, when the agricultural machine is in the automatic operation mode, the wheels of the agricultural machine drive the steering wheel 710 to rotate. The torque of the steering wheel 710 during the steering wheel 710 driving the wheel to turn is greater than the torque of the steering wheel 710 during the wheel driving the steering wheel 710 to rotate. Therefore, it can be determined whether the steering wheel 710 is under manual control or wheel control according to the torque of the steering wheel 710.

In some embodiments, it is determined that the agricultural machine is in a manual intervention status when the processor 110 detects that the pressure detected by the first pressure sensor 721 is greater than a first preset pressure value. Specifically, when the agricultural machine is in the manual control status, the first pressure sensor 721 on the brake pedal 720 outputs a first signal. When the agricultural machine is in the automatic operation mode, the first pressure sensor 721 on the brake pedal 720 outputs a second signal. The first signal is different from the second signal, so that the first signal and the second signal can be used to determine whether the agricultural machine is in the manual control status or the automatic operation mode. In this embodiment, when the second signal is approximately 0 (i.e., the value output by the first pressure sensor 721 when the first pressure sensor 721 does not detect the signal), it is indicated that the agricultural machine is in the automatic operation mode, and the first preset pressure value is equal to 0. On the other hand, when the first signal is greater than 0, it is indicated that the brake pedal 720 of the agricultural machine is in the manual control status. Correspondingly, the agricultural machine is in the manual control status, and the agricultural machine needs to be switched from the automatic operation mode to the manual operation mode.

In some embodiments, the user operation device 700 includes an accelerator pedal 730 provided at the agricultural machine and a second pressure sensor 731 provided at the accelerator pedal 730, where the second pressure sensor 731 is electrically connected to the processor 110. It is determined that the agricultural machine is in a manual intervention status when the processor 110 detects that the pressure detected by the second pressure sensor 731 is greater than a second preset pressure value. Specifically, when the agricultural machine is in the manual control status, the second pressure sensor 731 on the accelerator pedal 730 outputs a third signal. When the agricultural machine is in the automatic operation mode, the second pressure sensor 731 on the accelerator pedal 730 outputs a fourth signal. The third signal is different from the fourth signal, so that the third signal and the fourth signal can be used to determine whether the agricultural machine is in the manual control status or the automatic operation mode. In this embodiment, when the fourth signal is approximately 0 (i.e., the value output by the second pressure sensor 731 when the second pressure sensor 731 does not detect the signal), it is indicated that the agricultural machine is in the automatic operation mode, and the second preset pressure value is equal to 0. On the other hand, when the third signal is greater than 0, it is indicated that the accelerator pedal 730 of the agricultural machine is in the manual control status. Correspondingly, the agricultural machine is in the manual control status, and the agricultural machine needs to be switched from the automatic operation mode to the manual operation mode.

In some embodiments, as shown in FIG. 6, the agricultural machine control system further includes an emergency stop switch 600 provided at the agricultural machine for controlling whether the agricultural machine works, which may include the moving and operation of the agricultural machine. The emergency stop switch 600 is electrically connected to the processor 110 of the agricultural machine control device 100. After controlling the agricultural machine to perform the operation in the automatic operation mode, the processor 110 controls the agricultural machine to stop moving and the relevant operation upon receiving a stop instruction sent by the emergency stop switch 600. Specifically, during the operation of the agricultural machine, when the actual path of the agricultural machine deviates from the operation path, the user can press the emergency stop switch 600, and the agricultural machine can control itself to stop moving and the relevant operation (i.e., the current operation) by cutting off the power.

The device embodiment corresponds to and may refer to the description of the method embodiment. The devices described above are merely illustrative. The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those of ordinary skill can understand and implement without creative work.

The terms of “an embodiment” or “one embodiment” indicates a particular feature, structure, or characteristic related to the embodiment is included in at least one embodiment of the present disclosure. In this specification, the schematic descriptions of the terms are not necessarily referring to the same embodiment. Furthermore, the particular feature, structure, or characteristic may be combined in any suitable manner in one or more embodiments.

As for the device embodiment, since it basically corresponds to the method embodiment, reference may be made to the description of the method embodiment for the relevant parts. The above devices are merely illustrative, where the units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those of ordinary skill in the art can understand and implement without creative efforts.

The description of “specific embodiment” or “some embodiments” means that specific features, structures, materials, or characteristics described in conjunction with the embodiments or examples are included in at least one embodiment or example of the present disclosure. In this specification, the schematic expressions of the above terms do not necessarily refer to the same embodiment or example. The specific features, structures, materials, or characteristics described may be combined in any suitable manner in one or more embodiments or examples.

Any process or method description in a flowchart or otherwise described herein can be understood as representing a module, fragment, or portion of code that includes one or more executable instruction for implementing a particular logical function or step of a process. And the scope of the embodiments of the present disclosure includes additional implementations in which the functions may be performed out of the order shown or discussed, including performing functions in a substantially simultaneous manner or in the reverse order according to the functions involved, which should be understood by those skilled in the art.

The logic and/or steps represented in the flowchart or otherwise described herein, for example, a sequenced list of executable instruction that can be considered to implement a logical function, can be embodied in any computer-readable medium and used by an instruction execution system, device, or device (e.g., a computer-based system, a system including a processor, or other systems that can fetch and execute instruction from an instruction execution system, device, or equipment), or can be used in combination with these instruction execution systems, devices or equipment. In this specification, a “computer-readable medium” may be any device that can contain, store, communicate, propagate, or transmit a program for use by or in connection with an instruction execution system, device or equipment. A more specific example (non-exhaustive list) of computer-readable media can include, electrical connection (electronic device) with one or more wires, portable computer disk enclosure (magnetic device), random access memory (RAM), read-only memory (ROM), erasable and programmable read-only memory (EPROM or Flash memory), fiber optic devices, and portable compact disc read-only memory (CDROM). The computer-readable medium may further be paper or other suitable medium on which the program can be printed, as it can be performed, for example, by optically scanning the paper or other medium, followed by editing, interpretation, or other suitable method if necessary to process to obtain the program electronically and then store it in computer memory.

It should be understood that each part of the present disclosure may be implemented by hardware, software, firmware, or a combination thereof. In the above embodiments, multiple steps or methods may be implemented by software or firmware stored in a memory and executed by a suitable instruction execution system. For example, if implemented in hardware, as in another embodiment, it may be implemented using any one or a combination of the following techniques known in the art, e.g., discrete logic circuits with logic gate circuits for implementing logic functions on data signals, special-purpose integrated circuits with suitable combinational logic gate circuits, programmable gate arrays (PGA), and field programmable gate arrays (FPGA), etc.

Those of ordinary skill in the art can understand that all or some of the steps carried by the above implementation method can be completed by a program instructing related hardware. The program can be stored in a computer-readable storage medium. When the program is being executed, one or a combination of steps of a method embodiment can be included.

In addition, the functional units in the various embodiments of the present disclosure may be integrated in one processing unit, or each unit may be an individual physically unit, or a plurality of units may be integrated in one unit. The above integrated modules can be implemented in the form of hardware or software functional modules. A method consistent with the disclosure can be implemented in the form of computer program stored in a non-transitory computer-readable storage medium, which can be sold or used as a standalone product.

The above described storage medium may be a read-only memory, a magnetic disk or an optical disk, etc. Although the embodiments of the present disclosure have been shown and described above, it can be understood that the above embodiments are exemplary and should not be construed as limitations on the present disclosure. Those skilled in the art can change, modify, substitute, and transform the above embodiments within the scope of the present disclosure.

It should be noted that in this specification, relational terms such as “first” and “second” are only used to distinguish one entity or operation from another entity or operation, and do not necessarily require or imply any such actual relationship or order between these entities or operations. The terms of “comprise,” “include,” or any other variation thereof are intended to encompass non-exclusive inclusion, so that a process, method, article, or device that includes a series of elements includes not only those elements but also other elements that are not explicitly listed, or elements that are inherent to the process, method, article, or device. Without more restrictions, the elements associated with the sentence “including a . . . ” do not exclude the existence of other identical elements in the process, method, article, or equipment including the elements.

The present disclosure has been described with the above embodiments, but the technical scope of the present disclosure is not limited to the scope described in the above embodiments. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the claims.

What is claimed is:

1. An agricultural machine control method comprising:
acquiring control information for an automatic operation mode of an agricultural machine, the control information including an operation path of the agricultural machine;
controlling the agricultural machine to perform an operation in the automatic operation mode according to the control information; and
sending, in response to determining that the agricultural machine is in an abnormal status, an interrupt signal to the agricultural machine to cause the agricultural machine to stop moving and stop the operation.

2. The method of claim 1, wherein acquiring the control information includes:
acquiring geographic information of an area to be operated and current position information of the agricultural machine; and
determining the operation path of the agricultural machine according to the geographic information and the current position information of the agricultural machine.

3. The method of claim 2, wherein acquiring the geographic information of the area to be operated includes acquiring position information of boundary points of the area to be operated.

4. The method of claim 3, wherein acquiring the position information of the boundary points of the area to be operated includes acquiring a key point on a boundary of the area to be operated, the key point including at least one of a corner position or a non-linear position.

5. The device of claim 4, wherein determining the operation path of the agricultural machine according to the geographic information and the current position information of the agricultural machine includes determining terrain information of the boundary of the operation area according to the position information of the key point

6. The method of claim 2, wherein acquiring the geographic information of the area to be operated includes:
acquiring position information of an obstacle in the area to be operated; or
acquiring position information of a boundary point of an area containing the obstacle in the area to be operated.

7. The method of claim 2, wherein acquiring the geographic information of the area to be operated includes acquiring the geographic information of the area to be operated through an input device of the agricultural machine.

8. The method of claim 7, wherein:
the input device is a touch screen; and
acquiring the geographic information of the area to be operated includes acquiring the geographic information of the area to be operated through an operation of a user on the touch screen.

9. The method of claim 2, wherein acquiring the current position information of the agricultural machine includes acquiring the current position information of the agricultural machine through a navigation device of the agricultural machine.

10. The method of claim 1, wherein:
the control information further includes position calibration information, the position calibration information including a preset position and positioning information corresponding to the preset position; and
controlling the agricultural machine to perform the operation in the automatic operation mode according to the control information includes calibrating a real-time position of the agricultural machine according to the calibration information.

11. The method of claim 10, wherein calibrating the real-time position of the agricultural machine according to the calibration information includes:
acquiring position information of the preset position detected by the agricultural machine when the agricultural machine is located at the preset position; and
calibrating a positioning deviation of the agricultural machine according to the positioning information of the preset position and the position information of the preset position detected by the agricultural machine.

12. The method of claim 1, wherein determining that the agricultural machine is in the abnormal status includes determining that an actual path of the agricultural machine deviates from the operation path and a deviation of the actual path from the operation path is greater than or equal to a preset deviation.

13. The method of claim 1, wherein determining that the agricultural machine is in the abnormal status includes determining that a coincidence degree between an actual path of the agricultural machine and the operation path is less than or equal to a preset coincidence degree.

14. The method of claim 1, wherein determining that the agricultural machine is in the abnormal status includes detecting that a communication link of a device of the agricultural machine is disconnected and a disconnection duration is greater than or equal to a preset duration, the device includes at least one of a control device, a navigation device, or an execution device.

15. The method of claim 14, wherein:
the control device includes at least one of a brake control device, an accelerator control device, or a steering control device;
the navigation device includes a real-time kinematic (RTK) device; and
the execution device includes at least one of a seeding device or a spraying device.

16. The method of claim 1, further comprising, after controlling the agricultural machine to perform the operation in the automatic operation mode:
receiving a parameter fed back from a functional device of the agricultural machine, the functional device including at least one of a real-time kinematic (RTK) device or an inertial measurement unit (IMU) device;
wherein determining that the agricultural machine is in the abnormal status includes detecting that the parameter fed back from the functional device is an invalid parameter.

17. The method of claim 1, wherein determining that the agricultural machine is in the abnormal status includes detecting that a control error generated by a control device of the agricultural machine is greater than or equal to a preset error value, and a duration of the control device generating the control error is greater than or equal to a preset duration.

18. The method of claim 1, further comprising, after controlling the agricultural machine to perform the operation in the automatic operation mode:
acquiring current status information of a user operation device of the agricultural machine; and
switching, in response to determining that the agricultural machine is in a manual intervention status according to the status information of the user operation device, the agricultural machine from the automatic operation mode to a manual operation mode.

19. The method of claim 18, wherein the status information of the user operation device includes at least one of a torque of a steering wheel of the agricultural machine, a pressure of a brake pedal of the agricultural machine, or a pressure of an accelerator pedal of the agricultural machine.

20. The method of claim 19, wherein:
the status information of the user operation device includes the torque of the steering wheel of the agricultural machine; and
determining that the agricultural machine is in the manual intervention status according to the status information of the user operation device includes determining that the agricultural machine is in the manual intervention status in response to the torque of the steering wheel being greater than or equal to a preset torque value.
